(19) United States
(12) Patent Application Publication
(10) Pub. No.: US 2023/0174224 A1
(43) Pub. Date: Jun. 8, 2023

(54) AIRCRAFT

(71) Applicants: Sylvain ROLDAN DE PERERA, Larmor Plage (FR); Dimitry Brega, Kharkov (UA)

(72) Inventors: Sylvain ROLDAN DE PERERA, Larmor Plage (FR); Dimitry Brega, Kharkov (UA)

(21) Appl. No.: 17/922,081

(22) PCT Filed: Apr. 28, 2021
(86) PCT No.: PCT/EP2021/061127

§ 371 Date: Oct. 28, 2022

(30) Foreign Application Priority Data
Apr. 29, 2020 (FR) 2004272

(51) Int. Cl. B64C 27/24; B64C 27/605; B64D 35/04; B64C 27/26

(52) U.S. Cl. CPC B64C 27/24; B64C 27/605; B64D 35/04; B64C 27/26

(57) ABSTRACT

An aircraft including at least one wing system with two wings rigidly connected to a rotor provided with a swash plate control device. The wing system being able to change from a fixed wing configuration where the rotor is immobilised relative to the aircraft fuselage and the wings are oriented with their leading edge facing the direction of forward travel of the aircraft, to a rotating wing configuration where the rotor is rotated relative to the fuselage, and conversely, at least one of the wings is itself subjected, during the change-over from the fixed wing configuration to the rotating wing configuration, to a rotation on itself relative to the rotor in such a manner that the two wings of the wing system form blades having their leading edge oriented in the direction of rotation of the rotor.

### TECHNICAL FIELD

The present invention relates to an aircraft having an adaptable wing structure able to pass from a fixed-wing configuration to a rotary-wing configuration, and vice versa.

### PRIOR ART

U.S. Pat. No. 8,070,090 describes an aircraft designed to pass from a helicopter mode with a rotary wing structure to an airplane mode with a fixed wing structure. The control of the orientation of the aircraft during flight is effected by virtue of servo motors which are disposed in the wings and which are designed to modify the incidence thereof.

Application WO 2014/089604 discloses an aircraft of the same type. In the rotary-wing flight configuration, the aircraft can be piloted by means of a swashplate device. The wing structure has blades with a symmetrical profile, that is to say that the leading edge has the same shape as the trailing edge. The aerodynamic performance is not entirely satisfactory in the fixed-wing flight configuration.

There exists a need to further improve aircraft that are able to change between fixed-wing and rotary-wing configurations, in order notably to improve the aerodynamic performance.

### DISCLOSURE OF THE INVENTION

The invention aims to meet this need.

### SUMMARY OF THE INVENTION

The invention achieves this by virtue of an aircraft comprising at least one wing structure with two wings secured to a rotor equipped with a swashplate control device, the wing structure being able to pass from a fixed-wing configuration in which the rotor is immobilized with respect to the fuselage of the aircraft and the wings are oriented with their leading edge facing in the direction of forward travel of the aircraft, to a rotary-wing configuration in which the rotor is driven in rotation with respect to the fuselage, or vice versa, at least one of the wings rotating on itself relative to the rotor, during the passage from the fixed-wing configuration to the rotary-wing configuration, such that the two wings of the wing structure form blades having their leading edge oriented in the direction of rotation of the rotor.

By virtue of the change of orientation of at least one of the wings, it is possible to use wings with a non-symmetrical profile, resulting in superior aerodynamic performance in flight with the fixed-wing configuration. Thus, the wings may have a profile which is optimized for flight in this configuration, reducing the drag and improving the autonomy. The swashplate control permits precise piloting in the rotary-wing configuration.

The passage of the wing structure from the fixed-wing configuration to the rotary-wing configuration, and vice versa, may be effected while the aircraft is in flight. This passage may be effected in an automatic manner, without an operator acting manually on the wings.

The rotary-wing configuration may be used during aircraft take-off and/or landing.

The aircraft may serve to transport passengers or, as a variant, constitute a drone.

It is possible for only one of the two wings to comprise a mechanism which transforms the movement of an actuator, which is integrated into the wing into a rotation of the wing on itself so as to modify the orientation of its leading edge between the fixed-wing and rotary-wing configurations.

By virtue of this mechanism, the leading edges of the wings are on the same side in the fixed-wing configuration, and face in opposite directions in the rotary-wing configuration.

Preferably, one wing is equipped with the rotation mechanism. Thus, the aircraft is more economical to design since it does not require that all the wings be equipped with such a mechanism. As a variant, both wings of the rotary wing structure are equipped with such mechanisms.

The angle of rotation of the wing on itself to pass from one configuration to the other is substantially equal to 180°.

At least one of the wings may comprise an actuator controlling the rotation of the wing on itself relative to a hub connecting said wing to the rotor, during the passage from the fixed-wing configuration to the rotary-wing configuration, and the swashplate control device may control the rotation of the hub on itself during the rotation of the rotor in the rotary-wing configuration.

The swashplate control may control the incidence of the wing and thus modify the lift in order to pilot the aircraft.

Furthermore, the wing may comprise a second actuator serving to move a lock which is movable relative to the wing between a first position allowing the wing to rotate under the action of the first actuator relative to the hub and a second position for locking the wing so as to oppose a rotation of the wing relative to the hub.

This lock makes it possible to block the wing in the rotary-wing configuration after it has rotated on itself to pass from the fixed-wing configuration to the rotary-wing configuration. Such locking helps to prevent the wing from rotating relative to the hub when said wing is in the rotary-wing configuration.

Preferably, one of the two wings of the wing structure is equipped with such a lock. As a variant, both wings are equipped with such locks.

Preferably, the lock engages, in a locking position, with an arm which is rigidly connected to the hub and which rotates therewith. This arm which is rigidly connected to the hub is, for example, substantially parallel to the root of the wing.

Advantageously, the lock is axially movable, but other locking movements are possible.

The swashplate control device may comprise an arm for controlling the incidence, the end of said arm being situated substantially at the same distance from the axis of rotation of the hub on itself as the lock.

The rotation of at least one wing on itself may be obtained by a mechanism which transforms a movement of an actuator into an axial movement of two parts relative to one another, these two parts being provided with cooperating reliefs which are configured to transform the axial movement of one part relative to the other into a rotation of one part relative to the other, one of the parts being secured to the rotor and the other to the wing.

The rotation of the wing on itself can thus be controlled in a precise manner by the actuator.

One of the parts may comprise at least one helical slot and the other at least one lug which moves in this slot, such that an axial movement of one of the parts in the slot is accompanied by a rotation of one of the parts relative to the other.

The swashplate control device may comprise a plate mounted on a ball joint allowing said plate to incline relative to the axis of rotation of the rotor, the plate being connected to link rods which control the incidence of the wings during the rotation of the rotor, the device comprising two link rods for controlling the inclination of the plate along the pitch and roll axes, respectively, said link rods being disposed at substantially 90° with respect to one another about the axis of rotation of the rotor. The swashplate control device may then comprise a single actuator controlling the collective pitch.

As a variant, the swashplate control device comprises a plate mounted on a ball joint allowing said plate to incline relative to the axis of rotation of the rotor, the plate being connected to link rods which control the incidence of the wings during the rotation of the rotor, the device comprising at least three link rods for controlling the orientation of the plate. In this case, the swashplate control device may advantageously comprise four link rods for controlling the orientation of the plate which are disposed at substantially 90° with respect to one another about the axis of rotation of the rotor. The presence of these four link rods permits good mechanical integrity of the swashplate control device.

Preferably, the aircraft comprises a propulsion unit at the rear, preferably a propulsion unit with two contra-rotating propellers, this serving to improve efficiency.

The rotor may be driven in rotation by a motor in the rotary-wing configuration.

In one embodiment variant, the rotor is disposed at the rear of the fuselage in the fixed-wing configuration and the axis of rotation of the rotor is substantially coaxial with the longitudinal axis of the fuselage. The aircraft may comprise at least one propulsion propeller which is driven in rotation by the same motor as the rotor in the fixed-wing configuration. The aircraft may also comprise a transmission with an epicyclic gear train allowing the motor to selectively drive the rotor or the propulsion propeller.

As a variant, the axis of rotation of the rotor is substantially perpendicular to the longitudinal axis of the fuselage.

In one embodiment variant, the aircraft comprises a second wing structure with two wings which are secured to a second rotor, this second wing structure being able to pass from a fixed-wing configuration in which the second rotor is immobilized with respect to the fuselage of the aircraft and the wings are oriented with their leading edge facing in the direction of forward travel of the aircraft, to a rotary-wing configuration in which the second rotor is driven in rotation with respect to the fuselage, and vice versa, at least one of the wings rotating on itself relative to the second rotor, during the passage from the fixed-wing configuration to the rotary-wing configuration, such that the wings form blades each having their leading edge oriented in the direction of rotation of the second rotor. This second rotor notably makes it possible to stabilize the aircraft in the rotary-wing configuration. The two rotors may be driven by separate transmissions. Thus, it is possible for the two rotors to not be synchronized, and this may be useful notably for making available an additional possibility for controlling the lift relative to each rotor.

Preferably, the aircraft comprises at least two fixed low wings. Such low wings facilitate the transition between the two flight configurations. Moreover, they also make it possible to optimize the lift of the aircraft when it has reached a sufficient flight speed in the rotary-wing or fixed-wing configuration. These complementary fixed wings also make it possible to limit the diameter of the disks of the rotors.

The two fixed low wings may each be provided with a propulsion unit, the control of the aircraft about the yaw axis then being easily obtained by adjusting a differential thrust exerted by the two propulsion units. These propulsion units are preferably propulsion units with propellers, which may be of smaller dimension than those of the aforementioned rear propulsion unit.

### BRIEF DESCRIPTION OF THE DRAWINGS

The invention may be understood better from reading the following detailed description of non-limiting examples of implementation thereof, and from examining the appended drawing, in which:

FIG. 1 schematically shows a perspective view of an example of an aircraft according to the invention, in the fixed-wing configuration,

FIG. 2 is a top view of the aircraft in FIG. 1,

FIG. 3 shows the aircraft in FIG. 1 in the rotary-wing configuration,

FIG. 4 is a top view of the aircraft in FIG. 3,

FIG. 5 is a schematic and partial perspective view of an example of a swashplate control device of an aircraft according to the invention,

FIG. 6 shows the device in FIG. 5 from another viewing angle,

FIG. 7 shows an example of a mechanism which makes it possible to modify the orientation of the leading edge of a wing relative to the rotor,

FIG. 8 shows a top view of the mechanism in FIG. 7,

FIG. 9 shows a partial and schematic side view of an aircraft variant, in the rotary-wing configuration,

FIG. 10 is a view similar to FIG. 9 during the passage to the fixed-wing configuration,

FIG. 11 is a view similar to FIG. 9 with the wings in the fixed-wing configuration,

FIG. 12 schematically shows a top view of the aircraft in FIG. 11, and

FIG. 13 is a partial and schematic view of the drive mechanism of the rotor.

### DETAILED DESCRIPTION

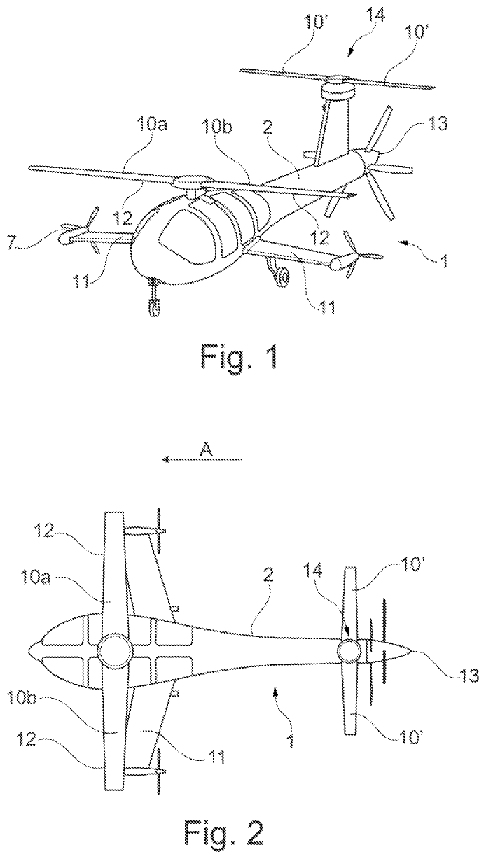

FIGS. 1 to 4 show an aircraft 1 suitable for transporting passengers or cargo.

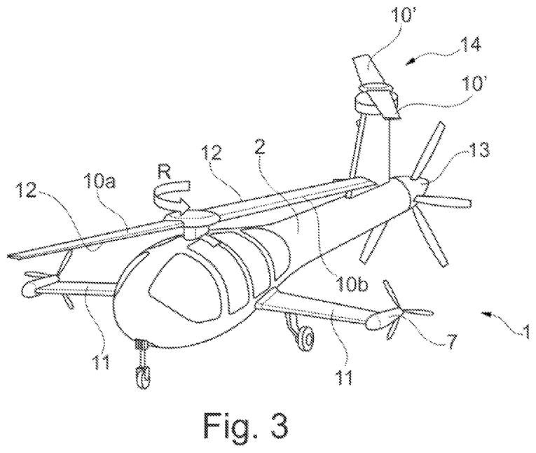

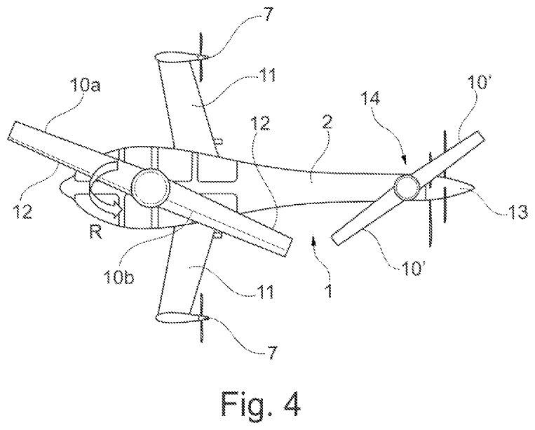

It comprises two wings 10a and 10b designed to pass from a fixed-wing configuration, illustrated in FIGS. 1 and 2, to a rotary-wing configuration, illustrated in FIGS. 3 and 4. These wings 10a, 10b are borne by a rotor.

In the example illustrated, the axis of rotation of the rotor is substantially perpendicular to the longitudinal axis of the fuselage 2.

The aircraft 1 comprises a second wing structure similar to the first, having two wings 10′ borne by a second rotor. This second wing structure is also able to pass from a fixed-wing configuration to a rotary-wing configuration. The axis of rotation of the second rotor is substantially perpendicular to the longitudinal axis of the fuselage 2.

The two rotors may rotate in opposite directions.

The aircraft 1 comprises two low wings 11 which are fixed. These low wings may have a forward-swept configuration, as illustrated.

The wings 11 facilitate the transition from one flight configuration to the other. They also provide greater lift in the fixed-wing flight configuration.

The wings 11 may each be equipped with a propulsion unit, for example a propulsion unit with a propeller 7. These propellers 7 may rotate at different speeds, and the resulting thrust differential makes it possible to control the aircraft 1 about the yaw axis.

The aircraft 1 comprises a propulsion unit at the rear. In the example shown, this propulsion unit comprises two contra-rotating propellers 13 each having three blades.

In the fixed-wing configuration, shown in FIGS. 1 and 2, the wings 10a and 10b are fixed relative to the fuselage, allowing the aircraft to move like an airplane, in rapid flight. In this configuration, the leading edges 12 of the wings 10a, 10b face in the direction of forward travel of the aircraft 1.

In the rotary-wing configuration, shown in FIGS. 3 and 4, the wings 10a, 10b form blades each having their leading edge 12 oriented in the direction of rotation R of the rotor. The leading edges 12 of the two wings face in opposite directions.

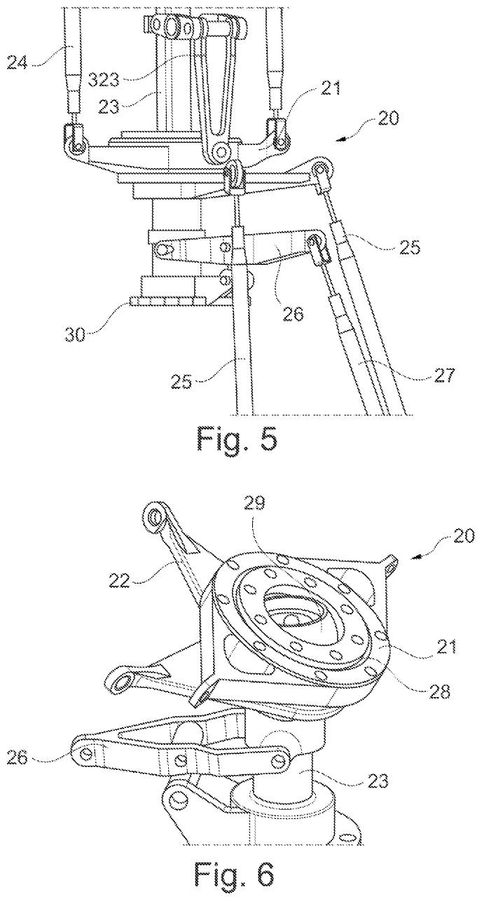

The aircraft 1 comprises a swashplate control device 20, making it possible to control the movement of said aircraft in the rotary-wing configuration. An example of this device is shown in FIGS. 5 and 6, in the knowledge that any known swashplate control device can be used.

In the example illustrated in FIGS. 5 and 6, the device 20 comprises a plate 21 mounted by way of rolling bearings 28 on a ball joint 29 allowing said plate to incline relative to the axis of rotation of the shaft 23 of the rotor. A lever 323 secured to the shaft 23 of the rotor drives the plate 21 in rotation while allowing it to pivot about an axis perpendicular to the axis of rotation of the shaft 23 of the rotor.

The plate 21 is connected to the wings 10a and 10b by link rods 24, which are visible in FIG. 5, so as to be able to control the incidence of said wings during the rotation of the rotor as a function of the inclination provided to the plate 21, as is conventional for helicopters. As a function of the inclination of the plate 21, and of its rotation about the pivot axis defined by the lever 323, the link rods 24 ascend or descend along the axis of rotation of the shaft 23.

The device 20 also comprises two link rods 25 for controlling the inclination of the plate 21, along the pitch and roll axes, respectively. These two link rods 25 are disposed at substantially 90° with respect to one another about the axis of rotation 23 of the rotor, and are connected to respective actuators (not shown).

The device 20 also comprises a link rod 27 making it possible to act on a lever 26 for controlling the collective pitch. This lever 26 is borne by a support part 30 which is fastened to the fuselage 2 and which is passed through by the shaft 23 of the rotor. The rotation of the lever 26 causes the plate 21 to ascend or descend on the shaft 23 of the rotor, and in so doing to act on the collective pitch. The lever 323 can pivot relative to the shaft 23 of the rotor during this axial movement of the plate 21.

The head 400 of the rotor bears two diametrically opposed hubs 210, each being able to rotate about their longitudinal axis, substantially perpendicular to the axis of rotation of the rotor.

Each wing 10a, 10b can rotate with this hub 210 when the rotor is in the rotary-wing configuration, during the rotation of the rotor, as a function of the inclination of the plate 21, due to the action of the link rods 24.

Each link rod 24 is connected at one end 24a to the plate 21 and at the other end 24b to a first arm 324 for controlling the rotation of the hub 210, close to the head 400 of the rotor.

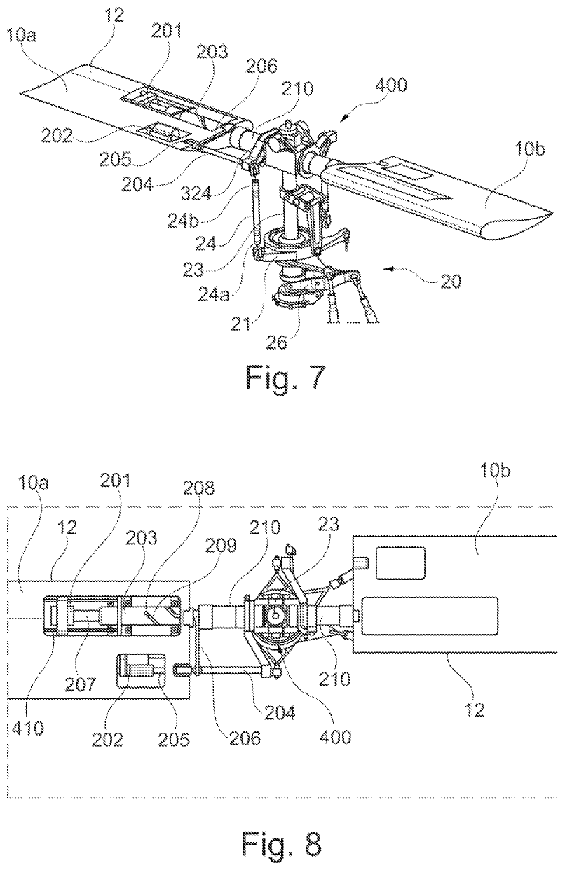

For one of the wings, specifically the wing 10a situated on the left in FIG. 7, a second arm 206 extends facing the first 324, those ends of the arms which are opposite to the hub 210 being connected by a connecting rod 204.

This wing 10a is equipped with a first actuator 201 allowing it to rotate relative to the hub 210 borne by the rotor, during the change of rotary-wing/fixed-wing configuration.

The actuator 201 serves to generate a relative axial movement within the wing between an internal shaft 207 and an external sleeve 203, which is rigidly fastened to the wing and in which the internal shaft 207 is engaged. The internal shaft 207 is secured, for conjoint rotation, to the hub 210. The sleeve 203 is provided with at least one helical slot 209 and the internal shaft 207 with at least one lug 208 engaged in this slot 209, such that the axial movement of the internal shaft 203 relative to the sleeve 207 is accompanied by a rotation of the wing 10a relative to the internal shaft 207. Said internal shaft can rotate within the actuator 201, without moving axially relative thereto. When the actuator 201 is actuated, it moves axially with the hub 207 along guides 410 which are secured to the wing 10a.

The wing 10a is equipped with a system for locking in the rotary-wing configuration, said system comprising a second actuator 202 serving to move a lock 205 axially between a first, retracted position allowing the wing 10a to rotate under the action of the first actuator 201 relative to the hub 210 of the rotor, and a second, deployed position in which said lock engages with a corresponding relief of the arm 206 to prevent the wing 10a from rotating relative thereto.

In the unlocked position, the movable lock 205 is not in engagement with the rigid arm 206. The wing 10a can thus rotate freely around the hub 210 under the action of the first actuator 201.

The actuators 201, 202 may be electrically powered from the rotor via slip rings. Said actuators may be controlled using carrier currents, for example.

In the case of manned flights, it is desirable to not suddenly stop the rotors and their disengagement is then effected using a clutch system. Thus, once the leading edges 12 have been engaged according to the desired flight configuration, the rotors rotate freely on themselves under the effect of the relative wind, induced by the thrust of the main motor, in the manner of an autogyro. This transitional mode makes it possible to accelerate or decelerate the rotors, during the passage from one configuration to the other. During braking, the propulsion units with propellers 7 that are situated at the end of the low wing 11 are employed to stabilize the aircraft which accelerates until the low wings generate sufficient lift. Henceforth, the rotors are braked by any suitable braking device, notably an electromagnetic braking device integrated into the rotors, and the immobilization is effected, for example, by hydraulic braking which also ensures the redundancy of the first braking. An encoder, for example an optical encoder, allows the position of the rotor to be determined during braking and its immobilization is realized accordingly. A gearbox and the controller of each motor make it possible, if necessary, to re-position the rotors after braking. The rotor may be is locked by a linear servo motor according to a mechanism similar to that described above.

An implementation variant of the invention, in which the aircraft 1 is a drone, is shown in FIGS. 10 to 13.

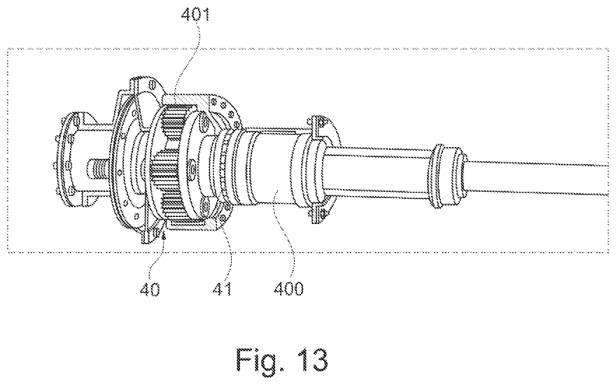

In FIG. 10, the aircraft 1 is shown in the rotary-wing configuration. In FIG. 13, the aircraft is in the fixed-wing flight configuration. The leading edges 12 of the wings are on the same side, in the direction of forward travel.

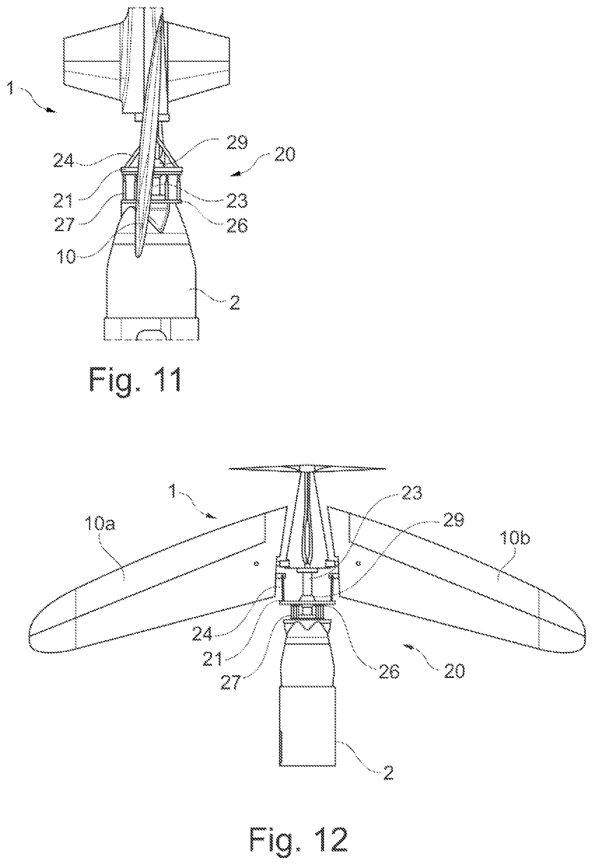

FIGS. 11 and 12 illustrate the change of fixed-wing/rotary-wing configuration. The rotor is disposed at the rear of the fuselage 2 and the axis of rotation of the shaft 23 of the rotor is substantially coaxial with the longitudinal axis of the fuselage 2.

In this embodiment, a swashplate control device 20 is disposed at the rear of the fuselage 2. Said swashplate control device comprises a plate 21 mounted on a ball joint 29 allowing it to incline relative to the axis of rotation of the rotor. The plate 21 is connected to four link rods 24 which are disposed at 90° with respect one another, allowing it to incline so as to control the movement of the drone about the roll and pitch axes in the rotary-flight configuration. The axial movement of the set of link rods 27 serves to control the collective pitch.

In this embodiment, at least one of the wings 10 is equipped with a mechanism which makes it possible to change the orientation of its leading edge, for example similar to the mechanism described with reference to FIGS. 6 and 7.

The same motor may selectively drive the rotor 400 or the propulsion propeller 13 in rotation, by virtue of an epicyclic gear train mechanism 40 shown in FIG. 13.

The epicyclic gear train mechanism 40 comprises, for example, an inner sun gear and a large ring gear which forms an integral part of the rotor 400. Planet gears 401 mesh with the inner sun gear and the large ring gear.

The rotor 400 is guided by rolling bearings 41.

When the large ring gear is free, rotation of the shaft of the motor drives that of the rotor 400, with a reduction ratio linked to the epicyclic gear train.

When the large ring gear is blocked, only the propulsion propeller 13 is driven in rotation by the motor.

In the exemplary embodiment of FIGS. 1 to 8, the aircraft may be in the rotary-wing configuration during take-off, then pass to the fixed-wing configuration during flight and finally return to the rotary-wing configuration for landing.

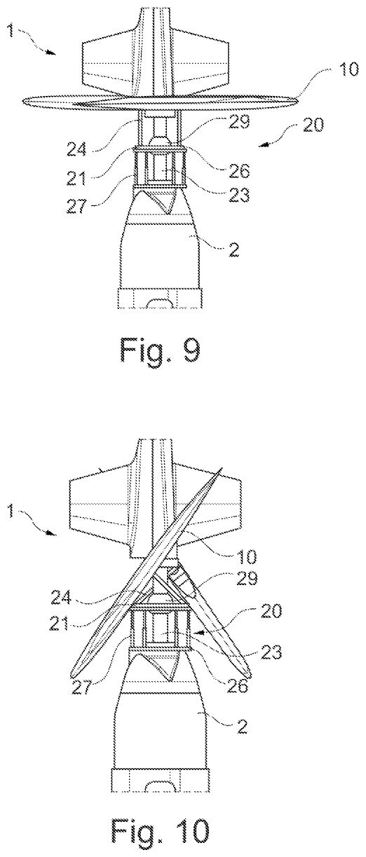

As a variant, notably for the embodiment of FIGS. 9 to 12, it is possible to launch the aircraft in a different manner, for example with the aid of a powder propulsion unit, with the wings in the fixed-wing configuration or else folded along the fuselage. In that case, the rotary-wing configuration may be used only for landing of the aircraft.

Of course, the invention is not limited to the exemplary embodiments which have just been described, and the manner in which the swashplate control device is implemented can be further modified, or modifications to the mechanism which makes it possible to change the orientation of the leading edge of the wings can be made.

1. An aircraft comprising at least one wing structure with two wings which are secured to a rotor equipped with a swashplate control device, the wing structure being able to pass from a fixed-wing configuration in which the rotor is immobilized with respect to the fuselage of the aircraft and the wings are oriented with their leading edge facing in the direction of forward travel of the aircraft, to a rotary-wing configuration in which the rotor is driven in rotation with respect to the fuselage, or vice versa, at least one of the wings rotating on itself relative to the rotor, during the passage from the fixed-wing configuration to the rotary-wing configuration, such that the two wings of the wing structure form blades having their leading edge oriented in the direction of rotation of the rotor.

2. The aircraft as claimed in claim 1, only one of the two wings comprising a mechanism which transforms the movement of an actuator, which is integrated into the wing, into a rotation of the wing on itself so as to modify the orientation of its leading edge between the fixed-wing and rotary-wing configurations.

3. The aircraft as claimed in claim 1, at least one of the wings comprising an actuator controlling the rotation of the wing on itself relative to a hub connecting said wing to the rotor, during the passage from the fixed-wing configuration to the rotary-wing configuration, and the swashplate control device controlling the rotation of the hub on itself during the rotation of the rotor in the rotary-wing configuration.

4. The aircraft as claimed in claim 3, the wing comprising a second actuator serving to move a lock which is movable relative to the wing between a first position allowing the wing to rotate under the action of the first actuator relative to the hub, and a second position for locking the wing so as to oppose a rotation of the wing relative to the hub.

5. The aircraft as claimed in claim 4, the lock engaging, in a locking position, with an arm which is rigidly connected to the hub and which rotates therewith.

6. The aircraft as claimed in claim 4, the lock being axially movable.

7. The aircraft as claimed in claim 4, the swashplate control device comprising an arm for controlling the incidence, the end of said arm being situated substantially at the same distance from the axis of rotation of the hub on itself as the lock.

8. The aircraft as claimed in claim 1, the rotation of at least one wing on itself being obtained by a mechanism which transforms a movement of an actuator into an axial movement of two parts relative to one another, these two parts being provided with cooperating reliefs which are configured to transform the axial movement of one part relative to the other into a rotation of one part relative to the other, one of the parts being secured to the rotor and the other to the wing.

9. The aircraft as claimed in claim 8, one of the parts comprising at least one helical slot and the other at least one lug which moves in this slot, such that an axial movement of one of the parts in the slot is accompanied by a rotation of one of the parts relative to the other.

10. The aircraft as claimed in claim 1, the swashplate control device comprising a plate mounted on a ball joint allowing said plate to incline relative to the axis of rotation of the rotor, the plate being connected to link rods which control the incidence of the wings during the rotation of the rotor, the device comprising two link rods for controlling the inclination of the plate along the pitch and roll axes, respectively, said link rods being disposed at substantially 90° with respect to one another about the axis of rotation of the rotor.

11. The aircraft as claimed in claim 10, comprising a single actuator controlling the collective pitch.

12. The aircraft as claimed in claim 1, the swashplate control device comprising a plate mounted on a ball joint allowing said plate to incline relative to the axis of rotation of the rotor, the plate being connected to link rods which control the incidence of the wings during the rotation of the rotor, the device comprising at least three link rods for controlling the orientation of the plate.

13. The aircraft as claimed in claim 12, the device comprising four link rods for controlling the orientation of the plate which are disposed at substantially 90° with respect to one another about the axis of rotation of the rotor.

14. The aircraft as claimed in claim 1, comprising a propulsion unit at the rear.

15. The aircraft as claimed in claim 1, the rotor being driven in rotation by a motor in the rotary-wing configuration, the aircraft comprising at least one propulsion propeller which is driven in rotation by the same motor in the fixed-wing configuration, the aircraft comprising a transmission with an epicyclic gear train allowing the motor to selectively drive the rotor or the propulsion propeller.

16. The aircraft as claimed in claim 15, the rotor being disposed at the rear of the fuselage in the fixed-wing configuration and the axis of rotation of the rotor being substantially coaxial with the longitudinal axis of the fuselage.

17. The aircraft as claimed in claim 1, the axis of rotation of the rotor being substantially perpendicular to the longitudinal axis of the fuselage.

18. The aircraft as claimed in claim 17, comprising a second wing structure with two wings which are secured to a second rotor, this second wing structure being able to pass from a fixed-wing configuration in which the second rotor is immobilized with respect to the fuselage of the aircraft and the wings are oriented with their leading edge facing in the direction of forward travel of the aircraft, to a rotary-wing configuration in which the second rotor is driven in rotation with respect to the fuselage, and vice versa, at least one of the wings rotating on itself relative to the second rotor, during the passage from the fixed-wing configuration to the rotary-wing configuration, such that the wings form blades each having their leading edge oriented in the direction of rotation of the second rotor.

19. The aircraft as claimed in claim 18, the two rotors being driven by separate transmissions.

20. The aircraft as claimed in claim 18, comprising at least two fixed low wings.

21. The aircraft as claimed in claim 20, the two fixed low wings each being provided with a propulsion unit, the control of the aircraft about the yaw axis being obtained by adjusting a differential thrust exerted by the two propulsion units.
